(19) United States
(12) Patent Application Publication
(10) Pub. No.: US 2012/0128978 A1
(43) Pub. Date: May 24, 2012

(54) METHOD FOR ENCAPSULATING LIQUID OR PASTY SUBSTANCES IN A CROSS-LINKED ENCAPSULATION MATERIAL

(76) Inventors: Thomas Ballweg, Kreuzwertheim (DE); Doris Hanselmann, Wuerzburg (DE); Carsten Gellermann, Gerbrunn (DE); Joern Probst, Kuernach (DE)

(21) Appl. No.: 13/318,056

(22) PCT Filed: Apr. 28, 2010
(86) PCT No.: PCT/EP2010/055704

§ 371 Date: Feb. 7, 2012

(30) Foreign Application Priority Data
Apr. 29, 2009 (DE) 1020090193707

(51) Int. Cl. D02G 3/36; B29C 47/06

(52) U.S. Cl. 428/391; 264/4; 428/394

(57) ABSTRACT

The present invention pertains to a method for encapsulating a liquid or pasty substance in a cross-linked encapsulation material, characterized in that the liquid or pasty substance and an inorganic at least partially condensed and organic polymerizable inorganic-organic hybrid material are co-extruded as a cross-linkable precursor material of the encapsulation material through a nozzle, such that the cross-linkable precursor material surrounds the liquid or pasty substance, whereupon the co-extruded material is passed through a zone, in which a cross-linking of the precursor material is brought about. In preferred embodiments, the precursor material for the encapsulation material may be produced from or using silanes of the formula (I)

RₐR¹_{b}SiX_{4-a-b} (I)

by means of hydrolytic condensation, wherein the substituents R, R¹ and X may each be the same or different and wherein R represents an organic radical that is bound to silicon via carbon and that can be cross-linked by heat or actinic radiation, R¹ represents a radical that is bound to silicon via carbon and that cannot be organically cross-linked, X is a group that can be hydrolyzed under hydrolysis conditions or that can be separated from the silicon, or is OH, a is 1 or 2, b is 0 or 1, and a+b may be 1 or 2. Inorganic hollow spheres or hollow fibers can optionally be produced by burning the organic components of the capsules or fibers obtained in this manner and evaporating the content.

The present invention pertains to an encapsulation method for encapsulating liquid or pasty substances as well as the capsules obtained by means of this method.

(Micro)encapsulation is a principle to enclose particulate solids, liquids or gases in small portions with a shell. This technique of jacketing (active) ingredients has great importance with highly rising tendency in the areas of pharmacy/medicine, cosmetics, nutrition/foods, the consumer sector and for the areas of textiles, chemistry, agriculture and environment. With the possibility of, e.g.,
transforming liquid substances into powders,
encapsulating highly volatile substances (aromas, fragrances),
protecting substances against reaction, e.g., with air, light or liquids,
releasing active ingredients in a controlled manner (e.g., medications),
fixing toxic substances,
keeping reactive substances separate from one another,
improving the tolerances of medications, and
improving physical properties of powders,
   not only new product qualities, but also new product ideas and strategies are offered.

Among the large number of encapsulation techniques, many are active-ingredient-specific, i.e., coordinated to exactly one active ingredient (e.g., coacervation). In other cases, heat is involved (thermoplastic melts), or a solvent is needed, such that sensitive materials may be damaged. One principle (i.e., the combination of material and method), which combines an especially gentle and clean encapsulation without heat tone, charging in of solvent, contamination or damage to sensitive contents by means of foreign substances with a high encapsulation efficiency and highest possible variability of the encapsulatable contents is not known up to now.

Depending on the physical and chemical properties of the active ingredients, the area of application and the desired function, there are the widest variety of encapsulation materials and encapsulation techniques. The most important methods that are predominant in terms of technical apparatuses are extrusion, spray drying, rotating disk and fluid bath technique. The application of heat, solvents, etc. cannot be avoided in most techniques. Methods utilizing chemical or physical phenomena, which are often based on self-forming processes (emulsion techniques, coacervation), have the advantage of higher economic efficiency compared to the sequential technical method, are, on the other hand, highly active-ingredient-specific, very highly limited with respect to the encapsulation materials and frequently have the drawback of low encapsulation efficiency and purity. In emulsion methods/coacervation, the active ingredient is first mixed into the later shell material. By compacting the shell material from the edge, the successive concentration of the active ingredient/contents takes place in the interior. Silica-based materials in turn need strongly basic conditions for precipitation. Consequently, the active components/contents are contaminated or destroyed.

Because of their variable profile of properties, inorganic-organic hybrid polymers have previously been suggested for a large number of applications, for example, for functional coatings (scratch-proof layers, barrier layers, etc.) as well as for membrane applications. It was also suggested to use them for passivation of (micro)electronic components, and especially as a final encapsulation layer on multilayer structures. In this case, the term “encapsulation” stands for the coating or embedding of structured components, but not for formation of self-supporting shells about contents of variable states of aggregation.

The object of the present invention is to provide an encapsulation method with fast curing, in which a charging of a solvent into the material to be encapsulated as well as a contamination or damage to sensitive contents by foreign substances is avoided and which usually manages without heat tone.

The encapsulation method according to the present invention comprises the co-extrusion of a cross-linkable precursor material of the later encapsulation material together with the respective contents, such that the cross-linkable precursor material is extruded as an outer jacket (e.g., annular) around the contents. Fiber-like or particulate structures, in which the contents are enclosed by the precursor material, can be obtained as needed by means of suitable processing. Immediately or soon after the extrusion step and preferably in relatively great spatial proximity to the extrusion device, the fibers or particles are preferably passed by means of gravity through a zone, in which the precursor material is cross-linked by external action. The cross-linking product forming thereby encloses the contents, which fills these structures, as a capsule or as a hollow fiber.

The cross-linkable precursor material of the encapsulation material is preferably an inorganic-organic hybrid material.

Inorganic-organic hybrid polymers are known in great numbers. The ORMOCER®s, which were developed by the Fraunhofer Institute for Silicate Research, represent a large group. These may be considered to be organopolysiloxanes or hydrolytic condensates of (semi-)metal compounds, and especially silicon compounds, which are modified (organically polymerizable/polymerized or not polymerizable) by organic radicals bound to the (semi-)metal. Besides silicon compounds, other hydrolyzable/hydrolyzed metal compounds, e.g., of aluminum, boron, germanium, etc. may be present.

The production of organically modified polysiloxanes or silicic acid condensates (frequently also called “silane resins”) and their properties have been described in a plethora of publications. E.g., reference may be made here to Hybrid Organic-Inorganic Materials, MRS Bulletin 26(5), 364ff (2001) vicariously. Quite generally, such substances are usually produced by means of the so-called sol-gel process, in which hydrolysis-sensitive, monomeric or precondensed silanes, possibly in the presence of other co-condensable substances such as alkoxides of boron, germanium, zirconium or titanium, as well as possibly of additional compounds, which can be used as modifiers or network modifiers, or of other additives, such as colorants and fillers, are subjected to a hydrolysis and condensation.

The cross-linkable precursor material for the encapsulation material of the present invention is preferably composed of at least one silane of formula (I)

RₐR¹_{b}SiX_{4-a-b} (I)

or using such a silane, wherein the substituents R, R¹ and X may each be the same or different and wherein R represents a radical that is bound to the silicon via carbon and can be organically cross-linkable by heat or actinic radiation, R¹ represents a radical that is bound to the silicon via carbon and that cannot be organically cross-linked, X is a group that can be hydrolyzed under hydrolysis conditions or can be separated from silicon, or is OH, a is 1 or 2, b is 0 or 1, and a+b may be 1 or 2.

The radical R can be cross-linked via one or more groups, and possibly by means of a heat-induced polymerization, but preferably by means of a polymerization induced by means of actinic radiation, and especially UV radiation. “Polymerization” shall be defined as a polyreaction, in which double bonds or rings capable of reacting under the effect of heat, light or ionizing radiation are converted into polymers (English: addition polymerization or chain-growth polymerization). Hence, examples of R are radicals with one or more nonaromatic C═C double bonds, and preferably double bonds, which are accessible to a Michael addition reaction, such as vinyls, styryls or (meth)acrylates. For example, a cationic polymerization may take place by means of a cationic UV starter, for example, with an epoxy system (see, e.g., C. G. Roffey, Photogeneration of Reactive Species for UV Curing, John Wiley & Sons Ltd, (1997)). As an alternative, the cross-linking may be carried out by means of other polyreactions such as ring-opening polymerization. Examples are reactions of epoxy- or norbornene-containing radicals R. In specific embodiments, this polyreaction may take place directly, e.g., between an epoxy-containing radical R at a first silane of formula (I) and an amine-containing radical R at a second silane of formula (I). The radical R usually contains at least two and preferably up to approx. 50 carbon atoms. The organically cross-linkable group may be bound directly or via a coupling group to the carbon skeleton of the radical R, which, for its part, may be straight-chain or branched-chain. Accordingly, the carbon chain of the radical R may possibly be interrupted by O, S, NH, CONH, COO, NHCOO or the like.

In an important embodiment of the present invention, the radical R contains one or more vinyl, norbornene and/or epoxy groups.

The radical R′ is not capable of such a reaction. It is preferably a possibly substituted alkyl, aryl, alkylaryl or arylalkyl group, whose substituents do not permit a cross-linking, whereby the carbon chain of these radicals may possibly be interrupted by O, S, NH, CONH, COO, NHCOO or the like. Preferred are radicals R′ with 1 to 30 or even up to 50, and more preferably 1 to 5 carbon atoms that are not interrupted. Unsubstituted or fluorinated alkyl groups with such a large number of carbon atoms are especially preferred, since they may contribute to a low water vapor permeation. The water vapor permeation may, however, also be lowered by R′ being substituted with one or more substituents with specific functionality, for example, with OH or acrylic acid groups as water vapor catchers or as hydrophobic modifiers.

The group X in formula (I) is a group that can be hydrolyzed under hydrolysis conditions or that can be separated from silicon, or it is OH. The person skilled in the art knows which groups are suitable for this. Usually, group X is hydrogen, halogen, hydroxy, alkoxy, acyloxy or NR″₂ with R″ equal to hydrogen or alkyl (preferably with 1 to 6 carbon atoms). Alkoxy groups are preferred as separable groups, especially lower alkoxy groups such as C₁-C₆ alkoxy.

Since the index b can be 0, the silane of formula I may have a radical R in combination with no or one radical R′ or two radicals R in combination with no or one radical R′. The alternative with two radicals R may be preferred in some cases, because a high organic cross-linking can bring about a high tightness of the encapsulation and thus a low water vapor permeation rate. In other cases, it is preferred to use at least one silane of formula (I) with only one radical R.

The precursor material for the encapsulation material may be produced using at least one other silane of formula (II)

R′ₐSiX₄₋ₐ (II)

wherein R′ and X are each the same or different and have the same meaning as in formula (I) and a may be 0, 1, 2, 3 or 4. By adding such silanes with a=0 or 1 to the mixture to be hydrolyzed and to be condensed, from which the encapsulation material is finally formed, the SiO portion of the resin, i.e., the inorganic portion, is increased. Consequently, the shrinkage which usually accompanies the polymerization can be reduced or entirely avoided. Therefore, a=0 or 1 is preferred in formula (II). Examples of such compounds are tetraethoxysilane and methyltrimethoxysilane or methyltriethoxysilane.

In this embodiment of the present invention, the precursor material is preferably produced using a compound having formula (II), which is selected from among methyltriethoxysilane, dimethyldiethoxysilane and phenyltriethoxysilane. A silane of formula (I), in which R contains at least one vinyl, norbornene, (meth-)acrylate or epoxy group or is this group, is especially preferably used.

Instead of this or possibly in addition to this, the precursor material that can be used according to the present invention may have been produced using at one silane having formula (III)

RₐR′₃₋ₐSiX (III)

wherein R, R′ and X have the meaning given above for formula (I), and a may be 1, 2 or 3. As a result, the organic portion of the material is increased, which may improve the elasticity of the material.

The encapsulation precursor material which is suitable for the present invention may contain other substances, e.g., organic compounds of metals of the main group III, of germanium and of metals of subgroups II, III, IV, V, VI, VII and VIII. These compounds are preferably complexes or chelated compounds, preferably lower (especially C₁-C₆) metal alkoxides. Organic compounds, which can be used as modifiers or as cross-linkers, are another example (in the latter case they preferably contain two radicals, which may each enter into a polyreaction with a radical R′ of the silane of formulas (I) and/or (III); examples are di(meth)acrylates, when the radicals R contain (meth)acrylate, e.g., dodecanediol dimethacrylate.

If a cross-linking shall be carried out by means of UV radiation, a suitable UV starter, e.g., Irgacure 184 or Genocure TPO or a combination of both is, moreover, added to the precursor material.

Moreover, other suitable additives, for example, a surfactant or the like, as explained further below, may be added to the precursor material.

The term “(meth-)acrylate,” and terms derived therefrom, as they are used in the present invention, comprise methacrylates, acrylates as well as in rare cases and [sic—the word “und” does not belong here—Tr.Ed.] mixtures of both, or are to be defined correspondingly.

It is evident from the above explanations that the capsule material can be selected depending on the need to be relatively or fully close to, e.g., water vapor or certain gases, or it is permeable for these substances. If the capsule material contains, for example, cross-linked acrylates or methacrylates, the capsule wall is frequently permeable to a high degree for water vapor. Such embodiments may in some cases be especially favorable, e.g., when a later drying out of the interior of the capsules is desired. In such cases, it is possible to use the method according to the present invention, although it is the goal of the method to encapsulate a solid, for example, a sugar or a salt. In other cases, the capsule wall should, on the other hand, be as moisture-proof as possible, for example, for the case of the encapsulation of hygroscopic or moisture-sensitive materials, including, e.g., such adhesive components as isocyanates or cyanurates. Here, besides the measures already mentioned above, it is suggested to use silanes of formula (I) for the precursor material, in which R contains a double bond bound in a cyclic ring, for example, in a norbornene group. The co-condensation with phenylsilanes of formula (II) also increases the moisture-proofness. Furthermore, it is helpful to work in one or more metal compounds of formula M^{III}L₃ L or M^{IV}L₄, wherein is a trivalent metal and M^{III} is a tetravalent metal and L is an alkoxy group or a complex ligand or a tooth of a polydentate complex ligand, which can be condensed into the precursor material of the capsule material. The metals for this may be selected from among main and subgroup elements. Examples of corresponding metal alkoxides are those of boron, aluminum, zirconium, germanium or titanium.

The precursor material for the encapsulation material is usually produced by means of the so-called sol-gel process from the monomeric metal compounds, especially the respective silanes. Inorganic cross-linking structures are formed in this process; the desired, inorganic (partially) condensed products are formed—usually after initiating hydrolysis. The sol-gel step usually takes place in a suitable solvent. Here, a resin is obtained, whose viscosity can be controlled by the degree of cross-linking The precursor material of the present invention is preferably used with only a small amount of solvent or diluent or—even more preferably—free from solvents; a dilution, e.g., for lowering the viscosity, is still possible in some cases. All in all, it should be heeded, however, that the solvent content is not too high (preferably it is not more than 5 wt. % to 10 wt. %), because, otherwise, there is the risk of destruction of the capsules, if after the curing the solvent evaporates and the capsule is stressed due to shrinkage. Due to the variability of the starting materials used as well as, e.g., of the degree of cross-linking of the prepolymers produced therefrom (which depends among other things on the number of groups X in the silanes of formula (I) or the other additives), a variation potential arises, which can be used for producing different shell materials and geometries.

In addition to the inorganic-organic hybrid material defined above, a purely organic, likewise cross-linkable material may optionally be added to the precursor material of the encapsulation material, and especially one that enters into a polyreaction, especially a polymerization reaction, under actinic radiation (e.g., UV or visible light). Acrylate-containing systems are an example of this. Depending on the need, monomers or oligomers or already higher prepolymerized compounds may be used for this, so that the material obtains the desired viscosity. The cross-linkable groups of the purely organic material can be selected, such that they copolymerize with those of the inorganic-organic hybrid material; however, they may also be incompatible with those of the inorganic-organic hybrid material in this respect and be selected, such that they form their own network penetrating the other network under the polymerization conditions.

According to the present invention, the contents are injected directly either in drops or in hollow fiber structures of the precursor material (also called condensate, prepolymer or resin) by means of a combination of nozzles from a usually annular nozzle and a central, usually concentric inner nozzle, which are then compacted. The forms may be converted into one another, i.e., depending on the process, essentially spherical capsules, rather than drop- or egg-shaped capsules, capsules that are connected to one another via thin webs of capsule material, fibers with periodically changing cavity diameter or fibers with cavity diameter remaining the same can be produced. The rheological behavior of the precursor material is adjusted, such that there is a suitable compromise between the surface tension-dominated drop behavior and the polymer fiber elongation behavior. The preferred viscosity range is from 0.01 Pas to 50 Pas, preferably 0.1 Pas to 50 Pas and especially preferably 1 Pas to 50 Pas or 0.5 Pas to 25 Pas, rather even only up to 10 Pas at room temperature for production of single or only weakly combined capsules. These viscosities make it possible for surface effects to be dominant. This also results in a maximum allowance for wall thickness variations of the encapsulation in the range of approx. 20 nm up to approx. 1 mm. If one works with viscosities that are above the mentioned range, one obtains capsules with larger diameters. For fibers, on average markedly higher viscosity ranges are selected, typically in the range of approx. 1,000 to 5,000 Pas. Together with the selection of a suitable curing behavior of the material (which is determined especially by the selection of the organically cross-linkable groups), the encapsulation process can therefore be suitably designed for the respective substance to be encapsulated or the desired area of application. The respectively desired viscosities may optionally also be controlled or adjusted via the temperature, at which the encapsulation is carried out.

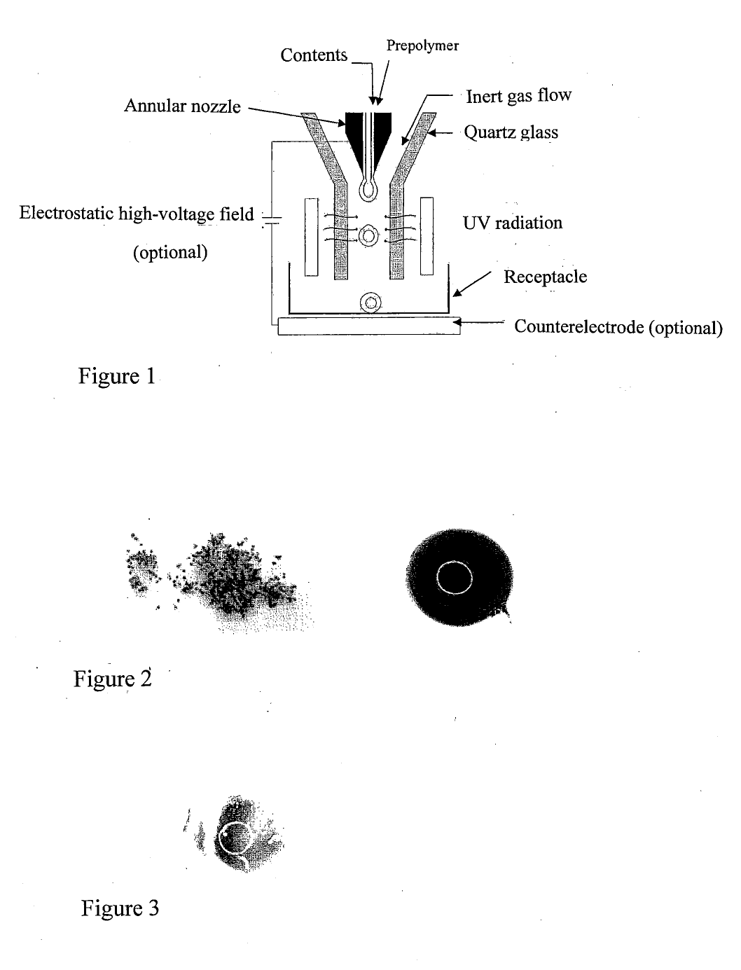

The technical sequence of the cross-linking reaction (curing reaction) is shown in FIG. 1 by way of example. The following is added: The capsules are produced by means of an annular nozzle with preferably a concentric inner nozzle, as already mentioned above. The substance to be encapsulated is passed by means of a suitable delivery means (e.g., by means of a hose pump or by applying pressure) into the nozzle construction together with the precursor material for the encapsulation material. The diameter of the outer nozzle is not specifically limited; it is typically in the range of approx. 5 mm to 0.1 mm, but it may be even one order of magnitude smaller for obtaining even smaller capsules. The diameter of the inner nozzle is harmonically adjusted to the outer diameter, thus accordingly is, for example, 2:3. The fine adjustment of the wall thicknesses of the capsules is, however, determined, above all, by parameters other than those of the nozzle geometry, e.g., by the selected delivery pressures, which may favorably be in the range of 0.1 bar to 5 bar overpressure in comparison to ambient pressure. It is preferred that the nozzle can be thermostatted separately, for example, in the range of 0° C. to 100° C. and typically in the range of 10° C. to 80° C. Consequently, relatively highly viscous contents and/or even relatively highly viscous resins as capsule material can be converted into the desired viscosity range without (because of the brief temperature load) any damage or undesired side effects occurring. With suitable adjustment of the process parameters (e.g., temperature in the range of approx. 5° C. to 30° C. and/or a delivery rate of approx. 10⁻⁴ cm³/min up to approx. 10 cm³/min for the resin and/or the contents—depending on the desired size/thickness of the capsules/fibers and desired relationship of encapsulated material to wall thickness), discrete spheres, ball chains threaded in the form of a string of pearls, or filled hollow fibers, consisting of a (partially) condensed, organically polymerizable, but not yet (completely) organically polymerized shell material with the contents in the interior, result. The diameter of the fibers or the sphere size is preferably in the range of 0.01 mm to 10 mm, especially preferably in the range 0.3-3 mm. The wall thickness is, as mentioned, variable in the range of approx. 20 nm to 1 mm. A particular advantage of the present invention is that especially also very thin wall thickness or capsule diameters can be obtained. A ratio of wall thickness to capsule diameter of 1:100 is readily possible. Thus, stable capsules of, e.g., 4 mm diameter with wall thickness of 40 μm can be produced.

According to the present invention, the capsules consisting of the material (contents) coated with prepolymer precursor are usually not collected in a liquid, but rather move after leaving the nozzle in free fall onto a curing zone and are thus accelerated under the impression of gravitational force. The greater the distance between the nozzle and the curing zone is, the faster they fall through the curing zone and thus the shorter is the residence time. However, a certain minimum for this distance is at least necessary when single capsules shall be formed: These usually first leave the nozzle in the drop form and need a certain time to form the desired (ideally spherical) geometry. The geometry of the device must take this into account because capsules form with unequal shell thickness, which have defects in the most unfavorable case, otherwise. A distance in the range of 10 cm to 50 cm has proven to be a favorable compromise. One or more diaphragms (especially iris diaphragms) may optionally be arranged within this fall distance in order to protect the nozzle against scattered light from the curing zone.

The contact time of the contents with the precursor material before the curing is usually altogether only a brief period of time (e.g., a few seconds, especially 1-2 sec.), so that the contents are neither contaminated nor loaded.

The curing zone may be an exposure zone; instead, however, it may also be a heat zone, if curing by heat shall be carried out. In the event of—preferably—cross-linking by actinic radiation, this curing zone is an area of high radiation intensity, which can be provided by conventional radiators such as UV radiators from the firms of Hoenle or Fusion. The length of the zone is, in principle, not set; it is favorably 15-60 cm. Instead of falling drops, a fiber might be pulled through or passively slide through the polymerization zone. An electrostatic high-voltage field between the annular nozzle and a counterelectrode can be provided under the receptacle to support the separation of the drops. For the same purpose, a vibration device may be provided as an alternative or in addition.

The residence time of the capsules in the curing zone depends on the length of the curing zone and the nozzle-curing zone distance, preferably from approx. 0.01 sec. to 0.5 sec., more preferably from approx. 0.03 sec. to 0.1 sec. With a curing zone length, especially a radiator length of 15 cm and a nozzle-radiator distance (which is preferably approx. 10-30 cm) of approx. 20 cm, a residence time of approx. 0.06 sec. is especially obtained as a typical residence time. If the curing is carried out by UV exposure, this period is sufficient when using suitable UV starters (see above) with sufficiently high radiation intensity. If an inhibition by atmospheric oxygen is observed, the radiation field may optionally be rinsed with inert gas. In especially thick shells, the capsules may also still be re-cured for complete thorough curing as needed by placing the receptacle in the scattered light area of the radiator.

As mentioned, the curing is carried out preferably by means of using actinic radiation, i.e., usually photochemically, for example, with visible light or UV radiation. Consequently, any thermal load of the contents is avoided (cold curing), and moreover, the (UV) radiation dose can also be limited for the case of light-sensitive contents.

If the capsule is formulated without active drop shearing off, i.e., the capsule is detached from the nozzle only under the impression of the gravity of the drops, then the size of the drops is primarily determined by the surface and interface properties of the contents and of the capsule material and by the nozzle geometry only to a lesser degree. To obtain smaller drop diameters, substances reducing the surface and interface tension (e.g., surfactants) may optionally be added. In this operating mode, one obtains capsules typically from 0.5 mm to 5 mm in diameter. Optionally, the shearing off and thus the separation of the drops for obtaining smaller diameters or for achieving a higher output can be supported by a special nozzle design, a directed gas flow, by vibrations, electrostatic fields or other mechanisms known among experts. In the event of the so-called laminar radiation decay, in which the drops are formed supported by vibrations, the capsule geometry arises directly from the nozzle dimensions. Depending on the precision of the nozzle design, capsule diameters of less than 100 μm are possible.

As upscaling principle, the parallelization of the method by means of multiple nozzles is the method of choice. Here, dozens (e.g., 50 to 100) of nozzles can be used.

Depending on whether the work is being done in single operation or parallel operation, the radiation field is to be illuminated differently. In the event of a single or monomodal operation, it is favorable to bundle the radiation intensity by means of an ellipsoid reflector or the like in a burn line, through which the capsules fall. In the event of a multimodal operation, a parabolic reflector geometry is advantageous, which provides for a uniform illumination of the radiation field.

As mentioned, the capsules are cross-linked, and preferably induced by light/UV radiation, e.g., by means of polymerization of double bonds present in the prepolymer. Depending on the spectrum of the radiation source used, the prepolymer is mixed beforehand with a suitable starter (e.g., Irgacure 184 or Lucirin TPO). With respect to a high rate of curing, acrylate silanes have an advantage over methacrylate silanes as compounds (I).

The advantages resulting from the cross-linking principle are the gentle and clean encapsulation, in particular, without heat tone, contamination of or damage to sensitive contents by means of foreign substances in combination with a very high variability of the contents that can be encapsulated. The method is simple, and aqueous or ethyl alcohol solutions, particle suspensions, oils or reactive substances can be encapsulated, whereby the same encapsulation material might be used basically for different contents (aqueous, oily, . . . ).

Substances encapsulated according to the present invention may be used in many, very different areas. The field of application extends, without excluding other areas, to the areas of pharmacy, cosmetics, automobile industry, nutrition, the consumer sector, textiles, chemistry, agriculture and environment.

In a special embodiment of the present invention, the finished capsules or other forms are pyrolyzed at high temperatures. As known from the state of the art, the pyrolysis may be carried out in two steps, whereby in a first step the material of the capsule wall is thermally cracked under inert gas and in a second step is heated in the presence of oxygen until the entire organic portion is “burned.” In this way, capsules or fibers are obtained from the corresponding inorganic oxides, for example, from SiO₂. If the capsules were filled with a volatile, evaporable material before this treatment, e.g., with water, then this [material] evaporates free from residue during the treatment, so that hollow spheres or fibers form.

The present invention shall be explained in detail below based on examples.

### EXAMPLE 1

### Encapsulation of Aqueous Colorants (Ink)

### 1. Synthesis of the Precondensed Resin (Precursor Material)

Mix trimethylolpropane triacrylate (TMPTA, 534 g) in ethyl acetate (1,500 mL). Add KOH in ethyl alcohol (97.6 g), then mercaptopropylmethyl dimethoxysilane (271 g); check the reaction using the iodine test. To initiate the hydrolysis/condensation of the acrylate silane formed, add water with HCl as the catalyst; processing: neutralize, wash, filter and subject to a rotary evaporator. The result is an oily, viscous liquid (approx. 15 Pas at room temperature) with a yield of approx. 500 g. Then stir in needed amount of starter (1.5% Irgacure 184).

### 2. Encapsulation Process

A triphenylmethane colorant in water is used as the ink. It is delivered by means of a hose pump through the central inner nozzle (diameter 0.7 mm) and resin by means of applying pressure through the concentric outer nozzle (diameter 1.2 mm) of a device as shown in FIG. 1 (resin temperature 10° C. corresponding to a resin viscosity of 45 Pas, delivery pressure 4.5 bar). Drops fall through a UV radiator (Fusion HP6) shielded by diaphragms, which is located 25 cm below the combination of nozzles.

Capsules are obtained with an average size of 2.8 mm with narrow distribution (±0.5 mm) and a wall thickness of approx. 0.2 mm in size. To some extent, the capsules are still connected via thin webs. These [webs] can be reformed or avoided entirely by changed process parameters (higher temperature, lengthening of the fall distance or radiation of the fall distance with IR radiation. The product (on the right: a capsule magnified many times) is shown in FIG. 2.

### EXAMPLE 2

### Encapsulation of Oily Substances

Encapsulation material and process as in Example 1, resin temperature 15° C. corresponding to a resin viscosity of 28 Pas and reduced delivery pressure (3.0 bar). A commercially available olive oil with a viscosity of 220 mPas is encapsulated.

Capsules are obtained with an average size of 2.0 mm with narrow distribution (±0.3 mm), on which a single thread of the encapsulation material still hangs. Such a capsule is shown in FIG. 3. Reformation by lengthening and heating the fall distance can be shown.

### EXAMPLE 3

### Encapsulation of Ethyl Alcohol Suspensions

Encapsulation material and process as in Example 1 at a resin temperature of 15° C. 10 wt. % SiO₂ particles in ethyl alcohol are used as the suspension.

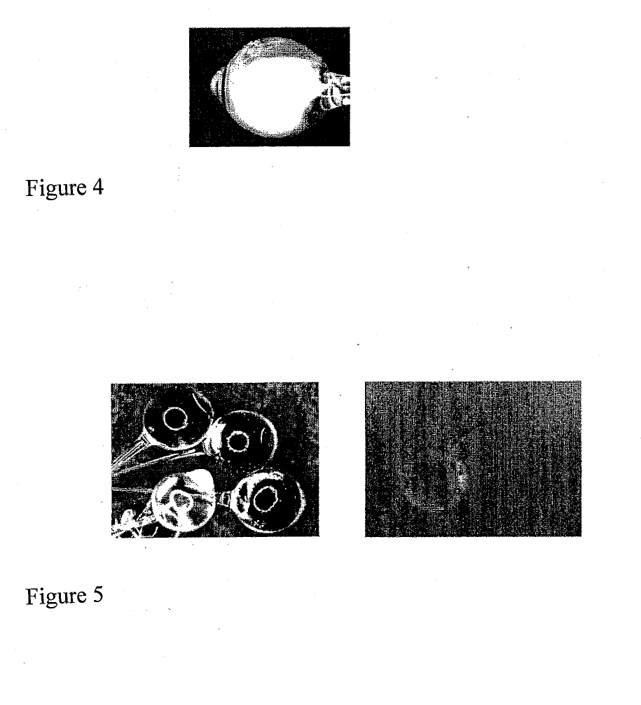

Capsules are obtained with thread lengthening of an average size of 2.0 mm with high scatter range (±1 mm) and thin wall thickness (<100 nm), which contain an ethyl alcohol suspensions [sic-Tr.] of silica nanoparticles. Such a capsule is shown in FIG. 4.

### EXAMPLE 4

### Encapsulation of Organic Reactive Monomers (Dodecanediol Dimethacrylate)

Encapsulation material and process as in Example 1 at a resin temperature of 15° C.

Capsules are obtained with a single thread of an average size of 2.2 mm and narrow distribution (±0.3 mm), which contain the reactive monomer dodecanediol dimethacrylate still in liquid, unreacted form. The reformation of the threads is possible by adequate temperature control (see FIG. 5).

### EXAMPLE 5

### 1. Synthesis of the Precondensed Resin (Precursor Material)

Mix trimethylolpropane [sic, obvious typo in original—Tr.Ed.] trimethacrylate in methyl isobutyl ketone. Add KOH in ethyl alcohol and then mercaptopropylmethyl dimethoxysilane to the addition synthesis. Prehydrolysis (3 hours) of the methacrylate silane formed with water and HCl as catalyst. Addition of methyltriethoxysilane and complete hydrolysis/condensation. Processing by means of neutralizing, washing, filtering and subjecting to rotary evaporator. The result is an oily liquid of 25 Pas at room temperature. Addition of the starter combination Irgacure 185 (0.5 wt. %) and Genocure TPO (0.5 wt. %).

### 2. Encapsulation of Concentrated Saline Solutions

Capsules of a concentrated saline solution with a filling volume of approx. 30 mm³ corresponding to a capsule outer diameter of approx. 4 mm were produced. The wall thickness was varied in the range of 0.05 mm to 0.5 mm by varying the delivery pressures. To optimize the spheres with respect to sphericity, the encapsulation was carried out at 50° C. corresponding to a viscosity of approx. 1 Pas.

### EXAMPLE 6

### 1. Synthesis of the Precondensed Resin (Precursor Material)

Glycerol-1,3-dimethacrylate [sic, typo-Tr.Ed.] was charged in, the catalyst dibutyl tin laurate was added and the addition was started by slowly adding 3-isocyanatopropyltriethoxysilane. Addition of dodecanediol dimethacrylate [sic, typo-Tr.Ed.] as the reactive monomer and network modifier and ethyl acetate as the solvent. Hydrolysis and condensation with water and ammonium fluoride as the catalyst. The processing was carried out by washing out the ammonium fluoride, filtering and then subjecting the residual solvent to a rotary evaporator. Addition of the starter combination Irgacure 185 (0.5 wt. %) and Genocure TPO (0.5 wt. %).

### 2. Encapsulation of Adhesive Components

55° C., corresponding to a viscosity of approx. 2 Pas, was selected as the processing temperature. Various adhesives were encapsulated. Single fractions (e.g., curing agent or resin components or both) of two-component adhesives were especially encapsulated. These were mixed together (e.g., encapsulated curing agent in resin) without reaction occurring. Only upon application does defined curing, precise in terms of time, occur with joining of the adhesive surfaces by means of mechanical cracking of the capsules. The necessary degree of homogenization and thorough mixing determines the size of the capsules. The glass-like brittle fracture behavior of the capsules favors the release without residue.

The size of the adhesive-filled capsules was varied by active vibration-induced drop shearing off in the range of 0.5 mm to 5 mm.

### EXAMPLE 7

### Capsule Material Corresponding to Example 5

Structurally viscous adhesive components mixed with Aerosil were encapsulated. Because of the pasty property, rice-grain-like geometries rather than spherical drops were obtained.

### EXAMPLE 8

### Capsule Material Corresponding to Example 6

Capsules filled with deionized water were produced. By drying at room temperature, the water was removed and hollow spheres were obtained (diameter approx. 4 mm, wall thickness 100 μm). Using a two-stage pyrolysis, microporous SiO₂ hollow spheres were obtained.

1. Method for encapsulating a liquid or pasty substance in a cross-linked encapsulation material, characterized in that the liquid or pasty substance and an inorganic at least partially condensed and organic polymerizable inorganic-organic hybrid material are co-extruded as a cross-linkable precursor material of the encapsulation material through a nozzle, such that the cross-linkable precursor material surrounds the liquid or pasty substance, whereupon the co-extruded material is passed through a zone, in which a cross-linking of the precursor material is brought about.

2. Method in accordance with claim 1, characterized in that the cross-linkable precursor material of the encapsulation material is an organopolysiloxane, which has organically cross-linkable groups, which are completely or at least partly bound to silicon atoms.

3. Method in accordance with claim 2, wherein the cross-linkable precursor material for the encapsulation material was produced from or uses at least one silane of the formula (I)
RₐR¹_{b}SiX_{4-a-b} (I)
wherein the substituents R, R¹ and X may each be the same or different and wherein R represents an organic radical that is bound to silicon via carbon and that can be cross-linked by heat or actinic radiation, R¹ represents a radical that is bound to silicon via carbon and that cannot be organically cross-linked, X is a group that can be hydrolyzed under hydrolysis conditions or that can be separated from the silicon, or OH, a is 1 or 2, b is 0 or 1, and a+b may be 1 or 2.

4. Method in accordance with claim 3, wherein at least some of the radicals R are selected from the group consisting of acrylate-containing, methacrylate-containing and epoxy-group-containing radicals.

5. Method in accordance with claim 3, wherein the precursor material for the encapsulation material was additionally produced using at least one other silane of the formula (II)
R¹ₐSiX₄₋ₐ (II)
wherein R¹ and X are each the same or different and have the same meaning as in formula (I), and a is 0, 1, 2, 3 or 4, and preferably 0 or 1.

6. Method in accordance with claim 3, wherein the precursor material for the encapsulation material was additionally produced using at least one silane having the formula (III)
RₐR¹₃₋ₐSiX (III)
wherein a may be 1, 2 or 3.

7. Method in accordance with claim 3, wherein the precursor material for the encapsulation material was additionally produced using at least one organic compound of a metal of the main group III, of germanium and/or of a metal of the subgroup II, III, IV, V, VI and VII.

8. Method in accordance with claim 3, wherein the precursor material was produced by means of a sol-gel process.

9. Method in accordance with claim 1, wherein the liquid or pasty substance and the precursor material are co-extruded through an annular nozzle, which is located next to or about a cross-linking zone, in which the co-extrudate is then subjected to an organic cross-linking under the effect of heat or actinic radiation.

10. Method in accordance with claim 9, characterized in that the cross-linkable precursor material of the encapsulation material has a viscosity in the range of 0.1 to 50 Pas and/or is extruded with an overpressure of 0.1 to 5 bar and/or with a delivery rate of 10⁻⁴ cm³/min to 10³ cm³/min.

11. Method in accordance with claim 9, wherein the co-extruded material is passed in free fall through the cross-linking zone, the cross-linking is performed by actinic radiation, and the residence time of the co-extruded material in the cross-linking zone is between 0.01 and 0.5 seconds, and preferably between 0.03 and 0.1 seconds.

12. Method in accordance with claim 11, wherein an electrostatic high-voltage field is applied between the nozzle and a background, on which is located a receptacle for the encapsulated material, and/or wherein vibrations are coupled into the head of the nozzle.

13. Method for producing oxidic hollow capsules or hollow fibers, characterized in that a substance that can be evaporated at high temperatures and an inorganic at least partially condensed and organically polymerizable inorganic-organic hybrid material in the form of a resin are co-extruded through a nozzle, such that the cross-linkable precursor material surrounds the evaporable substance in the form of capsules or fibers, whereupon the co-extruded material is passed through a zone, in which a cross-linking of the organically polymerizable groups of the inorganically at least partially condensed and organically polymerizable inorganic-organic hybrid material is brought about by polymerization, after which the capsules or fibers filled with the evaporable substance are subject to pyrolysis at a temperature, at which the evaporable substance evaporates from the capsules or fibers, and the material of the capsule or fiber walls is converted into the corresponding oxide.

14. Method in accordance with claim 13, wherein the inorganic at least partially condensed and organic polymerizable inorganic-organic hybrid material in the form of a resin was produced from or using at least one silane of the formula (I)
RₐR¹_{b}SiX_{4-a-b} (I)
wherein the substituents R, R¹ and X may each be the same or different and wherein R represents an organic radical that is bound to silicon via carbon and that can be cross-linked by heat or actinic radiation, R¹ represents a radical that is bound to silicon via carbon and that cannot be organically cross-linked, X is a group that can be hydrolyzed under hydrolysis conditions or that can be separated from the silicon, or OH, a is 1 or 2, b is 0 or 1, and a+b may be 1 or 2.

15. Method in accordance with claim 14, wherein at least some of the radicals R are selected from selected from the group consisting of acrylate-containing, methacrylate-containing and epoxy-group-containing radicals.

16. Fibers made of a liquid or pasty fiber core, which is surrounded by a shell, characterized in that the shell is formed from an inorganic at least partially condensed and organic polymerized inorganic-organic hybrid material.

17. Fibers in accordance with claim 16, wherein the hybrid material is an organopolysiloxane.
